(19) United States
(12) Patent Application Publication
(10) Pub. No.: US 2026/0142463 A1
(43) Pub. Date: May 21, 2026

(54) SERIES-TYPE FLEXIBLE TRANSFER CONVERTER SUPPORTING FULLY AUTONOMOUS CONTROL OF MICROGRID AND CONTROL METHODS

(71) Applicant: XI'AN JIAOTONG UNIVERSITY, Xi'an (CN)

(72) Inventors: Jinjun LIU, Xi'an (CN); Zhaoqi SONG, Xi'an (CN); Ronghui AN, Xi'an (CN); Zeng LIU, Xi'an (CN)

(73) Assignee: XI'AN JIAOTONG UNIVERSITY, Xi'an (CN)

(21) Appl. No.: 19/450,809

(22) Filed: Jan. 16, 2026

Related U.S. Application Data
(63) Continuation of application No. PCT/CN2023/139979, filed on Dec. 19, 2023.

(30) Foreign Application Priority Data
May 17, 2023 (CN) 202310565967.3

(51) Int. Cl. H02J 3/08; H02J 3/16; H02J 3/38; H02J 3/48; H02M 1/36; H02M 7/5387

(52) U.S. Cl. CPC H02J 3/08; H02J 3/16; H02J 3/381; H02J 3/48; H02M 1/36; H02M 7/53871

(57) ABSTRACT

The present disclosure discloses a series-type flexible transfer converter supporting fully autonomous control of a microgrid and control methods. The series-type flexible transfer converter connects to a first power grid and a second power grid. The control methods can realize pre-charging self-start of a device without relying on an energy storage and additional control circuit, achieve asynchronous grid connection without directly controlling each distributed power source within the microgrid, and softly switch to direct grid connection through a bypass switch after pre-synchronization to reduce losses. When a power grid needs emergency power support, active power can be transmitted to the power grid. The above functions are achieved by controlling the series-type flexible transfer converter instead of each distributed power source in the microgrid, thereby supporting fully autonomous control of the microgrid, and device costs and operating losses are reduced compared to a flexible transfer converter based on a back-to-back converter.

### CROSS-REFERENCE TO RELATED APPLICATIONS

The application claims priority to Chinese patent application No. 202310565967.3, filed on May 17, 2023, the entire contents of which are incorporated herein by reference.

### TECHNICAL FIELD

The present disclosure belongs to the field of AC microgrid control, and specifically relates to a series-type flexible transfer converter supporting fully autonomous control of a microgrid and control methods.

### BACKGROUND

A microgrid is a small power system that can be connected to new energy generation and conventional energy generation. The microgrid improves power supply reliability while avoiding losses caused by long-distance power transmission. The microgrid typically contains a large number of distributed power sources, most of which are connected to a microgrid bus through a power electronic converter interface, such as an inverter. In order to ensure the normal and efficient operation of the microgrid, on the one hand, it is necessary to coordinate and control the converters within the microgrid. On the other hand, the microgrid as a whole needs to interact effectively with a large power grid and cooperate to fully leverage the advantages of the microgrid. The large power grid refers to conventional power grid infrastructure. If each key device of the microgrid realizes autonomous control based on detecting the main circuit signal of the device itself without relying on communication, it is called fully autonomous control of the microgrid. If the fully autonomous control of the microgrid can be realized in the above two aspects, the fully autonomous control not only greatly improves system reliability but also enables plug-and-play operation of devices, which will bring great convenience to the device installation, operation, and maintenance.

The distributed power sources within the microgrid are geographically dispersed. In order to achieve coordinated control, existing centralized control methods often rely on communication, resulting in high costs and relatively low reliability. In particular, when there are a large number of internal distributed power sources and the microgrid as a whole needs to interact with the power grid, the existing methods that rely on direct communication between a central controller and the distributed power sources are difficult to achieve the fully autonomous control of the microgrid.

Regarding the coordinated control strategy between the converters within the microgrid, a fully autonomous control method, such as droop control, has attracted widespread attention. The method can basically ensure reasonable power distribution and coordinated operation among parallel distributed power sources without relying on communication. In research on the interaction between the microgrid as a whole and the large power grid, interface equipment between the power grids and control strategies thereof are core technologies. Early interface equipment mostly adopted grid-connected switches with simple functions, providing only on/off control. With the opening and closing of the grid-connected switches, the microgrid switches between island mode and grid-connected mode. The safe operation of the microgrid depends on the smoothness of the switching between the two modes, and the microgrid has different requirements for control characteristics and control targets of the distributed power sources in the two modes. After the switch from grid-connected mode to island mode, the distributed power sources in the microgrid need to have voltage support capabilities; and before the switch from island mode to grid-connected mode, it is necessary to coordinate the distributed power sources to complete voltage pre-synchronization of the microgrid bus and the large power grid connection point. After grid connection, continuous adjustment of grid connection power depends on the dispatch of each distributed power source. When interface equipment is a grid-connected switch, effective interaction between the microgrid and the large power grid can be achieved, generally relying on direct control of the distributed power sources to adjust the control strategy and the control target to meet the requirements of both grid-connected and island modes.

Therefore, in terms of effective interaction between a microgrid and a large power grid, the core problem of achieving fully autonomous control of a microgrid can be summarized as: how to achieve power transmission between a microgrid and a large power grid according to a higher-level command or local requirements without directly controlling each distributed power source within the microgrid in real time, while ensuring that the power transmission process has the characteristics of continuous adjustment, low loss and high efficiency.

When interface equipment is a grid-connected switch, the premise for power transmission between actual power grids is that the grid-connected switch is closed. In order to prevent impact caused by directly interconnecting two AC power grids with different voltage amplitudes and phase angles, pre-synchronization needs to be completed first. A passive pre-synchronization method closes the switch after detecting that the phase angle difference between the two ends is zero, and it takes a long time when the frequency difference is small; and an active pre-synchronization method requires high-bandwidth communication with each distributed power source within the microgrid to synchronously adjust the output voltage, and when there are many power sources, the system cost and reliability are unacceptable. In recent years, based on existing transmission and distribution power grid interconnection equipment such as smart transformers, power electronic transformers, variable-frequency transformers, and power routers, researchers have provided a flexible transfer converter with power electronic equipment as the core, which is used as interface equipment between a microgrid and a power grid to achieve fully autonomous control of the microgrid. A general-purpose flexible transfer converter that has been provided consists of a voltage-source back-to-back converter and a controllable parallel switch, combining the advantages of high controllability of a power electronic converter and low loss of a parallel switch. Power between power grids can be continuously adjustable through the power electronic converter. When the reduction of grid connection losses is required, pre-synchronization is achieved by adjusting interactive power between the power grids, and then switching to a switch grid-connected mode. However, there are problems such as high losses in a two-stage power converter for power flow, a large number of semiconductor switching devices in the equipment, and high costs.

### SUMMARY

In order to overcome the defects of the above-mentioned prior art, the purpose of the present disclosure is to provide a series-type flexible transfer converter supporting fully autonomous control of a microgrid and control methods. On the one hand, pre-charging self-start control without relying on any additional energy storage unit can be realized. On the other hand, asynchronous grid connection can be achieved without directly controlling each distributed power source within the microgrid in real time, and losses can be reduced by softly switching to direct grid connection through a bypass switch according to requirements; moreover, when a power grid needs emergency power support, active power can be transmitted from another power grid to the power grid to be supported through the series-type flexible transfer converter; and device costs and operating losses are significantly reduced compared to a general-purpose flexible transfer converter based on a back-to-back converter.

The present disclosure is implemented by the following technical solution:

A series-type flexible transfer converter supporting fully autonomous control of a microgrid, including a main circuit and a control circuit for controlling operation of the main circuit, in which the main circuit includes a pre-charging switch SW₁, a phase selection switch SW₃, a bypass switch SW₄, a line cut CUT, and a power electronic converter for converting DC into AC, in which the line cut CUT is connected in parallel with the bypass switch SW₄; and an AC side of the power electronic converter is connected to the line cut CUT, and an end of a parallel structure of the line cut CUT and the bypass switch SW₄ is connected in parallel with the pre-charging switch SW₁ and then connected in series with the phase selection switch SW₃; and
a buffer resistor R_{dc} is connected in series with a positive or negative end of a DC-side capacitor C_{dc} of the power electronic converter, and a buffer resistor bypass switch SW₂ is connected in parallel with both ends of the buffer resistor R_{dc} at the positive or negative end of the DC-side capacitor C_{dc}; and the number of phases of the pre-charging switch SW₁, the number of phases of the phase selection switch SW₃, the number of phases of the bypass switch SW₄, and the number of phases of the power electronic converter are the same as the number of phases of a power grid.

The present disclosure provides a control method for the series-type flexible transfer converter supporting fully autonomous control of a microgrid as described above. The control method is used to control pre-charging self-start of the series-type flexible transfer converter supporting fully autonomous control of a microgrid and is implemented by a control circuit controlling a main circuit. The control method includes the following process:
before a pre-charging self-start process starts, a pre-charging switch SW₁, a buffer resistor bypass switch SW₂, a phase selection switch SW₃, and a bypass switch SW₄ are all in the disconnected state;
when the power grid is a single-phase power grid, one end of the pre-charging switch SW₁ is connected to a phase line of a power grid and the other end is connected to a neutral line of the power grid; after a pre-charging command is received, the pre-charging switch SW₁ is closed, power transistors in a power electronic converter are all locked at this time, and a power grid voltage charges the DC-side capacitor through an uncontrolled rectifier; and after a peak impulse current of charging disappears, the buffer resistor bypass switch SW₂ is closed to bypass a buffer resistor R_{dc};
when the power grid is a three-phase power grid, three terminals at one end of the pre-charging switch SW₁ connected to the power grid are connected to three phases of the power grid, and three terminals at the other end are electrically connected together; after the pre-charging command is received, the pre-charging switch SW₁ is closed, the three-phase terminals of SW₁ connected to the one end of the power grid are short-circuited, the power transistors in the power electronic converter are all locked at this time, and the power grid voltage charges the DC-side capacitor through the uncontrolled rectifier; and after the peak impulse current of charging disappears, the buffer resistor bypass switch SW₂ is closed to bypass the buffer resistor R_{dc}; and
the control circuit starts working by drawing power autonomously from the DC-side capacitor, and then controls the power electronic converter to perform phase-locking of an AC port voltage of the power electronic converter, to work in a PWM rectifier mode with a unity power factor, and to absorb active power from the power grid so that a DC-side capacitor voltage is adjusted to a reference value. The present disclosure further provides another control method for the series-type flexible transfer converter supporting fully autonomous control of a microgrid. The another control method is used to control a pre-synchronization between a first power grid and a second power grid, and a phase selection switch SW₃ is connected to the first power grid, and the other end of a parallel structure of a line cut CUT and a bypass switch SW₄ is connected to the second power grid, and the control method is implemented by a control circuit controlling a main circuit. The another control method includes the following process:
when a DC side of a power electronic converter has an energy storage and additional control circuit, active power transmitted between the first power grid and the second power grid is adjusted directly by the power electronic converter controlling reactive power that is output by an AC port of the power electronic converter, so that a phase angle of the first power grid voltage and a phase angle of the second power grid voltage are pre-synchronized, and then the bypass switch SW₄ is closed, and the pre-synchronization control between the first power grid and the second power grid is completed; and
when the DC side of the power electronic converter lacks the energy storage and additional control circuit, the pre-charging self-start of the series-type flexible transfer converter supporting fully autonomous control of a microgrid is performed according to the self-start method above; and subsequently, the active power transmitted between the first power grid and the second power grid is adjusted by the power electronic converter controlling the reactive power that is output by the AC port of the power electronic converter, so that the phase angle of the first power grid voltage and the phase angle of the second power grid voltage are pre-synchronized, and then the bypass switch SW₄ is closed, and the pre-synchronization control between the first power grid and the second power grid is completed. The present disclosure further provides another control method for the series-type flexible transfer converter supporting fully autonomous control of the microgrid. The another control method is used to realize emergency power support of a power grid, and a phase selection switch SW₃ is connected to a first power grid, and another end of a parallel structure of a line cut CUT and a bypass switch SW₄ is connected to a second power grid, and the control method is implemented by a control circuit controlling a main circuit. The another control method includes the following process:
when a DC side of a power electronic converter has an energy storage and additional control circuit, active power transmitted between the first power grid and the second power grid is adjusted by a power electronic converter controlling reactive power that is output by an AC port of the power electronic converter, so as to complete emergency power support for a certain power grid; when the DC side of the power electronic converter lacks the energy storage and additional control circuit, the pre-charging self-start of the series-type flexible transfer converter supporting fully autonomous control of a microgrid is performed according to the self-start method above; the active power transmitted between the first power grid and the second power grid is adjusted by the power electronic converter controlling the reactive power that is output by the AC port of the power electronic converter, so as to complete the emergency power support for a certain power grid; in which the another control method includes the following steps:
step 1), starting the series-type flexible transfer converter supporting fully autonomous control of a microgrid, and controlling a DC-side capacitor voltage to a reference value;
step 2), detecting frequencies of the first power grid and the second power grid, determining whether the first or the second power grid needs the emergency power support according to a set power grid frequency threshold, and identifying a power grid to be supported; or identifying the power grid to be supported according to a higher-level command; and after identifying the power grid to be supported, disconnecting a pre-charging switch SW₁;
step 3), selecting a closing phase sequence of the phase selection switch SW₃, in which the phase selection switch SW₃ only needs to select the closing phase sequence when the first power grid and the second power grid are three-phase power grids; the control circuit selects the closing phase sequence of SW₃ according to the relative relationship between a first power grid voltage phasor and a second power grid voltage phasor; a selection criterion for the closing phase sequence is that after the phase selection switch SW₃ is closed under the selected phase sequence, phase angle difference of the power grid voltage phasor on both sides of the line cut CUT is minimized; and when the first power grid and the second power grid are single-phase power grids, the phase selection switch SW₃ does not need to select a phase, and the phase selection switch SW₃ can be directly closed in subsequent steps;
step 4), making the power electronic converter work in a voltage mode through the control circuit, in which in the case of a single-phase power grid, an instantaneous value of a voltage difference between the first power grid and the second power grid is sampled and calculated as a voltage command, and then the power electronic converter is controlled to make voltages at both ends of the line cut CUT follow the voltage command, so that a voltage amplitude difference between two ends of the phase selection switch SW₃ is zero before the closing thereof; and subsequently, the phase selection switch SW₃ is closed to establish an electrical connection between the first power grid, the line cut CUT and a device connected to the line cut CUT and the second power grid; and
in the case of a three-phase power grid, in the voltage mode, according to the phase sequence selected in step 3), an instantaneous value of the voltage difference between the first power grid and the second power grid is sampled and calculated as a voltage command, and then the power electronic converter is controlled to make voltages at both ends of the line cut CUT follow the voltage command, so that under the selected phase sequence, a voltage amplitude difference between two ends of the phase selection switch SW₃ is zero before the phase selection switch SW₃ is closed; and subsequently, the phase selection switch SW₃ is closed according to the selected phase sequence to establish an electrical connection between the first power grid, the line cut CUT and the device connected to the line cut CUT and the second power grid;
step 5), after the phase selection switch SW₃ is closed, transitioning the power electronic converter from the voltage mode to a current mode, and completing the transition to lead the power electronic converter to work in the current mode; step 6), after the power electronic converter enters the current mode, calculating a difference between a DC voltage reference value and a DC voltage actual value of the power electronic converter, and sending the difference to a DC voltage controller of the control circuit to obtain an active current command of the power electronic converter; and calculating a difference between a frequency reference value and a frequency actual value of the power grid to be supported, and sending the difference to an emergency power support controller of the control circuit to obtain a reactive current command of the power electronic converter; in which
the active current command and the reactive current command of the power electronic converter are as follows:

$$\{ \begin{matrix}{i}_{FTCd}^{*} = {G}_{p} \cdot ( {u}_{dc \_ ref} - {u}_{dc} ) \\ {i}_{FTCq}^{*} = {G}_{f} \cdot ( {ω}_{ref} - {ω}_{12} )\end{matrix}$$

in which, i*_{FTCd} and i*_{FTCq} are the active current command and the reactive current command of the power electronic converter, respectively, Gₚ and G_{f} represent the DC voltage controller and the emergency power support controller, respectively, u_{dc_ref} and u_{dc} are the DC voltage reference value and the DC voltage actual value of the power electronic converter, respectively, and ω_{ref} and ω₁₂ are the frequency reference value and the frequency actual value of the power grid to be supported, respectively; and
step 7), according to the current command obtained in step 6), generating a modulation wave by the control circuit using current closed-loop control, generating a drive signal through a pulse width modulation process, and controlling turning on or off of each of the power transistors according to the obtained drive signal by a drive circuit of each of the power transistors in the power electronic converter, so as to realize transmission of the active power to the power grid to be supported and the emergency power support for the power grid.

Compared with the prior art, the present disclosure has the following beneficial technical effects:
The present disclosure supports the series-type flexible transfer converter supporting fully autonomous control of the microgrid, aiming to solve the problem of how to achieve fully autonomous control of a microgrid when the microgrid is connected to a large power grid or interconnected with the microgrid. Moreover, compared with existing general-purpose flexible transfer converters based on back-to-back converters, the series-type flexible transfer converter described herein further reduces costs and power losses, realizing pre-charging self-start control of the series-type flexible transfer converter without adding additional energy storage devices. Compared with grid connection through static switches or other interface converters, the present disclosure can not only realize operation of asynchronous grid connection in real time to ensure power exchange between two certain power grids, but also can softly switch to operation of direct grid connection through power flow control when long-term grid connection operation is required to reduce overall losses. Moreover, when a power grid needs emergency power support, active power can be transmitted from another power grid to the power grid to be supported through the series-type flexible transfer converter. The present disclosure only needs to control the series-type flexible transfer converter during the entire working process, avoiding direct real-time control of each distributed power source within an AC microgrid connected to the series-type flexible transfer converter, thereby supporting fully autonomous control of a microgrid and having good engineering application prospects.

### BRIEF DESCRIPTION OF DRAWINGS

To illustrate technical solutions in embodiments of the present disclosure or the prior art more clearly, drawings to be used for describing the embodiments or prior art are introduced briefly in the following. Apparently, the drawings in the following description are some embodiments of the present disclosure, and persons of ordinary skill in the art can derive other drawings from these drawings without creative efforts.

FIG. 1 is a schematic diagram of a system structure of a series-type flexible transfer converter of the present disclosure;

FIG. 2 is a typical topological structure diagram of a series-type flexible transfer converter in an embodiment of the present disclosure;

FIG. 3 is a diagram of voltage phasors and current phasors of a system including a series-type flexible transfer converter, and of a detailed structure of a phase selection switch SW₃, in an embodiment of the present disclosure;

FIG. 4 is a control system block diagram of a series-type flexible transfer converter in an embodiment of the present disclosure, in which FIG. 4 (a) is a control block diagram of a phase-locked loop and voltage-current Park transformation of the series-type flexible transfer converter of the present disclosure; FIG. 4 (b) is a control block diagram of a DC voltage of the series-type flexible transfer converter of the present disclosure; FIG. 4 (c) is a control block diagram of pre-synchronization of the series-type flexible transfer converter of the present disclosure; FIG. 4 (d) is a logic diagram of a control mode switching of the series-type flexible transfer converter of the present disclosure; FIG. 4 (e) is a control block diagram of emergency power support of the series-type flexible transfer converter of the present disclosure; and FIG. 4 (f) is a control block diagram of a voltage-current control loop of the series-type flexible transfer converter of the present disclosure;

FIG. 5 is a timing diagram of a control signal and a switch state of a series-type flexible transfer converter in an embodiment of the present disclosure;

FIG. 6 is a waveform diagram of relevant electrical quantities in a simulation result of a series-type flexible transfer converter completing pre-charging self-start and subsequently controlling phase angle pre-synchronization between a microgrid and a large grid in an embodiment of the present disclosure, in which FIG. 6 (a) is a waveform diagram of active powers output by the series-type flexible transfer converter and by the microgrid; FIG. 6 (b) is a waveform diagram of phase angle difference of grid voltages at both ends of a primary side of a series transformer Ts; FIG. 6 (c) is a waveform diagram of reactive powers output by the series-type flexible transfer converter and by the microgrid; FIG. 6 (d) is a waveform diagram of a DC voltage reference value and a DC voltage actual value of the power electronic converter; FIG. 6 (e) is a waveform diagram of a voltage of a secondary side of the series transformer Ts; FIG. 6 (f) is a waveform diagram of a current of the bypass switch SW₄; FIG. 6 (g) and FIG. 6 (h) are enlarged views of the voltage waveforms in FIG. 6 (e) for different time periods; and FIG. 6 (i) is an enlarged view of the current waveform in FIG. 6 (f); and

FIG. 7 is a waveform diagram of relevant electrical quantities in a simulation result of a series-type flexible transfer converter realizing emergency power support for a microgrid in an embodiment of the present disclosure, in which FIG. 7 (a) is a waveform diagram of active powers output by the series-type flexible transfer converter and by the microgrid; FIG. 7 (b) is a waveform diagram of phase angle difference of grid voltages at both ends of a primary side of a series transformer Ts; FIG. 7 (c) is a waveform diagram of reactive powers output by the series-type flexible transfer converter and by the microgrid; FIG. 7 (d) is a waveform diagram of a frequency of the microgrid; FIG. 7 (e) is a waveform diagram of a voltage of a secondary side of the series transformer Ts; and FIG. 7 (f) is a waveform diagram of a current flowing through the primary side of the series transformer Ts.

### DETAILED DESCRIPTION OF THE EMBODIMENTS

The present disclosure provides a series-type flexible transfer converter for realizing fully autonomous control of a microgrid. In order to make the purpose and technical solution of the present disclosure clearer and easier to understand, the present disclosure will be further described in detail below with reference to the drawings and embodiments. The embodiments described herein are only to explain the present disclosure, and are not intended to limit the present disclosure.

The technical solution of the present disclosure will be clearly and completely described below with reference to the drawings and embodiments. Obviously, the embodiments described are some rather than all of the embodiments of the present disclosure. Based on the embodiments described herein, all other embodiments obtained by those of ordinary skill in the art without creative work are within the scope of the present disclosure.

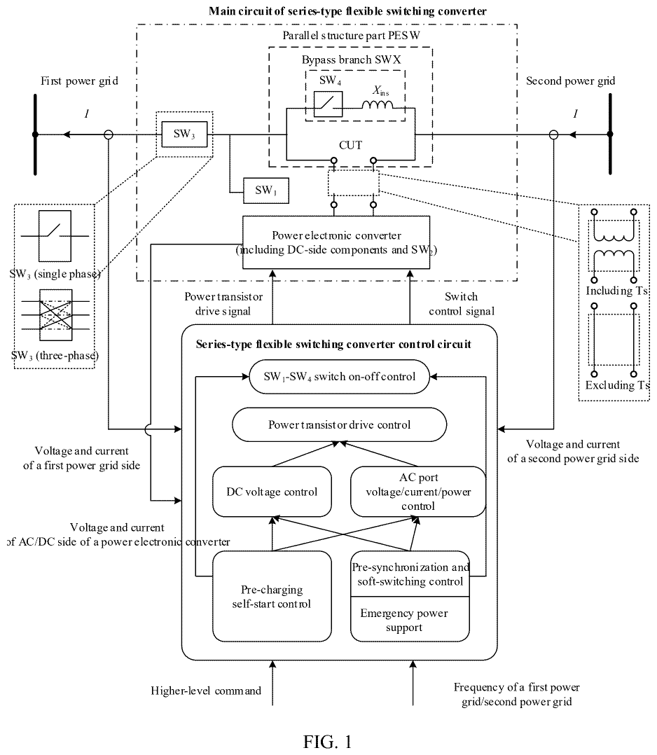

Referring to FIG. 1, the series-type flexible transfer converter supporting fully autonomous control of a microgrid provided by the present disclosure includes a main circuit and a control circuit for controlling operation of the main circuit, in which the main circuit includes a pre-charging switch SW₁, a phase selection switch SW₃, a bypass switch SW₄, a line cut CUT, and a power electronic converter for converting DC into AC, in which the line cut CUT is connected in parallel with the bypass switch SW₄; and an AC side of the power electronic converter is connected to the line cut CUT, and an end of a parallel structure of the line cut CUT and the bypass switch SW₄ is connected in parallel with the pre-charging switch SW₁ and then connected in series with the phase selection switch SW₃; and
a buffer resistor R_{dc} is connected in series with a positive or negative end of a DC-side capacitor C_{dc} of the power electronic converter, and a buffer resistor bypass switch SW₂ is connected in parallel with both ends of the buffer resistor R_{dc} at the positive or negative end of the DC-side capacitor C_{dc}; and the number of phases of the pre-charging switch SW₁, the number of phases of the phase selection switch SW₃, the number of phases of the bypass switch SW₄, and the number of phases of the power electronic converter are the same as the number of phases of a power grid.

Referring to FIG. 1, the series transformer Ts can provide isolation and functions such as adapting the voltage level of the power grid for the power electronic converter. It should be understood that the series transformer Ts is optional rather than mandatory.

If there is the series transformer Ts between the power electronic converter and the line cut CUT, both ends of a primary side of the series transformer Ts are connected to the line cut CUT, and a secondary side of the series transformer Ts is connected to the AC side of the power electronic converter.

In the case of a three-phase power grid, a connection method of a secondary winding of the series transformer Ts can be adjusted according to voltage levels and actual needs; according to actual needs, an auxiliary winding can be added to the series transformer Ts; and a turns ratio between the windings of the series transformer Ts can be set as needed, and rated operating frequency of the series transformer Ts is determined according to an actual power grid frequency, such as 50 Hz or 60 Hz.

In the case where the series transformer Ts is not included, the power electronic converter is directly connected in series with the line cut CUT part, and the power electronic converter selects a suitable topology accordingly, such as a cascaded H-bridge topology.

The bypass switch SW₄ can add a series reactance Xᵢₙₛ, which is optional rather than mandatory, and a reactance value can be determined according to actual working conditions; a branch formed by connecting the bypass switch SW₄ and the series reactance Xᵢₙₛ in series is called a bypass branch SWX; and after the line cut CUT part and the two ends of the bypass branch SWX are connected in parallel, this connection structure is referred to as the main circuit's parallel structure part PESW;

One end of the parallel structure part PESW is connected in parallel with the pre-charging switch SW₁ and then in series with the phase selection switch SW₃, and then, the parallel structure part PESW is connected to a first power grid through the phase selection switch SW₃; Subsequently, the other end of the parallel structure part PESW is connected to a second power grid; and through the above approach, the main circuit of the series-type flexible transfer converter is connected to the first power grid and the second power grid.

Voltage levels of the first power grid and the second power grid are the same, or the voltage levels are different but become the same voltage level after an additional step-up or step-down transformer. The first power grid is a three-phase or single-phase AC microgrid and the second power grid is a three-phase or single-phase large power grid, or the first power grid is a three-phase or single-phase large power grid and the second power grid is a three-phase or single-phase AC microgrid, or the first power grid and the second power grid are two three-phase or single-phase AC microgrids.

At least a portion of distributed power sources in the microgrid adopts grid-forming control with active power-frequency droop.

According to the single-phase or three-phase type of the power grid and whether the series transformer Ts is included, the power electronic converter can accordingly adopt a single-phase half-bridge circuit or a single-phase full-bridge circuit, a three-phase half-bridge circuit or a three-phase full-bridge circuit, a single-phase or three-phase cascaded H-bridge circuit, or other DC-to-AC power electronic converter circuit topologies that can generate a sinusoidal fundamental voltage at an AC port; and the power electronic converter may be a two-level, three-level, or multi-level converter.

A filter circuit of the power electronic converter is a single-inductor (L) filter circuit or an inductor-capacitor (LC) filter circuit.

Power transistors in the power electronic converter are MOSFETs, IGBTs, IGCTs, or other fully controlled power electronic switch devices, and each of the power transistors includes an anti-parallel body diode or an additional anti-parallel diode.

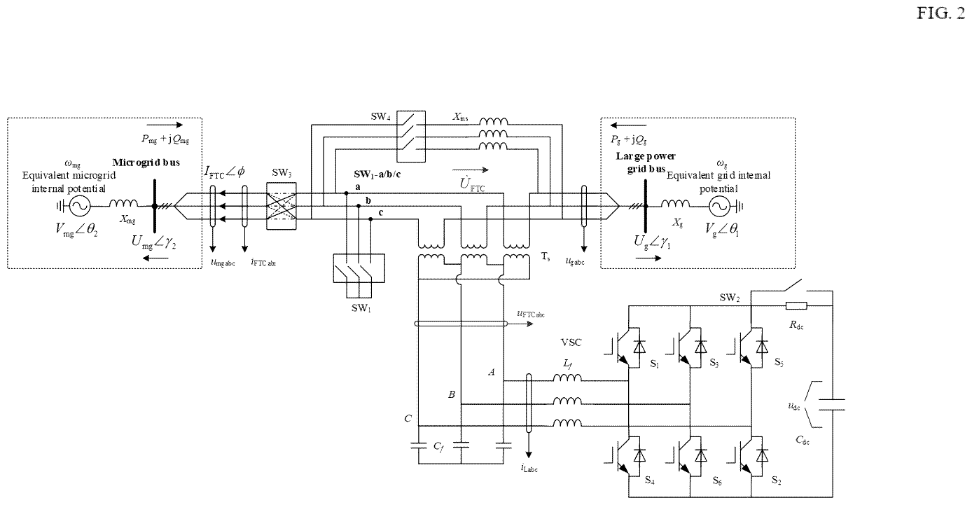

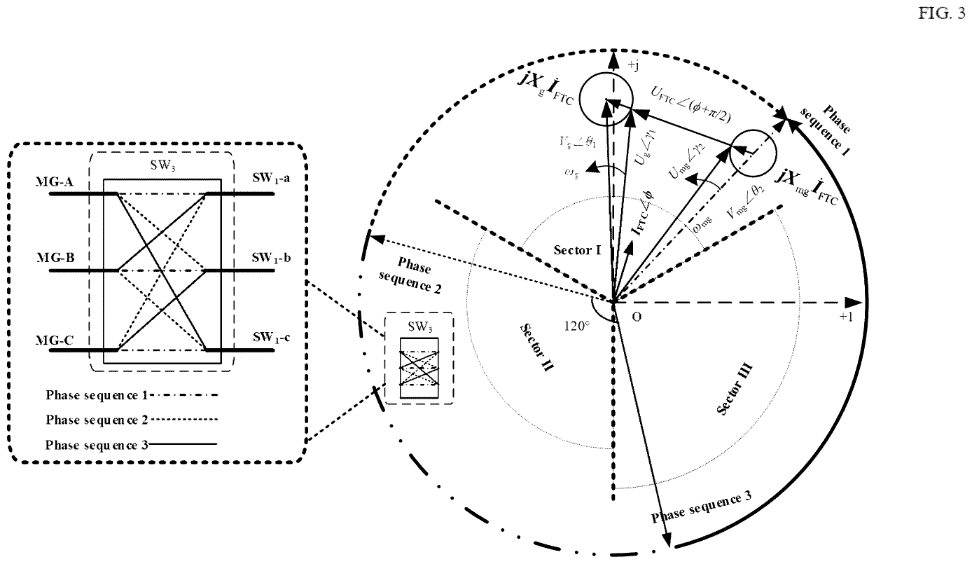

FIG. 2 shows a typical topological structure of a specific embodiment of the series-type flexible transfer converter applied in a three-phase AC microgrid and a three-phase large power grid; and in this specific embodiment, referring to a system structure of FIG. 1, the first power grid in FIG. 1 is a three-phase AC microgrid in FIG. 2, and the second power grid in FIG. 1 is a three-phase large power grid in FIG. 2, but it should be noted that this is an example of the present disclosure and not a limitation; and FIG. 3 shows voltage phasors and current phasors related to the series-type flexible transfer converter applied in the system shown in FIG. 2, and a detailed structure of the phase selection switch SW₃.

Referring to FIG. 2, V_{g}∠θ₁ and V_{mg}∠θ₂ are the equivalent internal potentials of the large grid and the microgrid, respectively. U_{g}∠γ₁ and U_{mg}∠γ₂ are the voltage phasors of the large power grid connection point and the microgrid bus, respectively. X_{g} and X_{mg} are the equivalent power grid impedances of the microgrid and the large grid, respectively. A current phasor flowing into the microgrid bus is I_{FTC}∠φ. If the active power absorbed by the series-type flexible transfer converter is ignored, the current phasor I_{FTC}∠φ is perpendicular to the voltage phasor U_{FTC}∠(_{φ}+π/2) on the primary side of the series transformer Ts; P_{mg} and Q_{mg}, P_{g} and Q_{g} are the active powers and the reactive powers output by the microgrid and the large grid, respectively. The connection method of the series transformer Ts, the pre-charging switch SW₁, the buffer resistor bypass switch SW₂, the phase selection switch SW₃, the bypass switch SW₄, and the series reactance Xᵢₙₛ in FIG. 2 is basically the same as that in FIG. 1, and will not be repeated here. In FIG. 2, the secondary winding of the series transformer Ts is connected in a delta configuration, and the primary-secondary turns ratio is 1:1.

Referring to FIG. 2, the characteristics of the three-phase AC microgrid in this specific embodiment are described:
In this microgrid, the equivalent impedance of the transmission line between each distributed power source and the common connection point is inductive. The active power P and the reactive power Q transmitted between the inverter output voltage E∠φ and the common connection point voltage U_{L}∠0 are defined as follows:

$$\{ \begin{matrix}P \approx \frac{{EU}_{L} ϕ}{Z} \\ Q \approx \frac{E ( E - {U}_{L} )}{Z}\end{matrix}$$

In the formula, E and U_{L} are the inverter output voltage and the voltage amplitude of the common connection point, respectively, φ is the phase angle difference between the power source and the common connection point, and Z is the equivalent impedance value of the transmission line.

In this case, at least a portion of the distributed power sources in the AC microgrid are voltage sources controlled by droop control. The specific control formula for droop control is as follows:

$$\{ \begin{matrix}{ω}^{*} = {ω}_{0} - {k}_{p} ( P - {P}_{0} ) \\ {E}^{*} = {E}_{0} - {k}_{q} ( Q - {Q}_{0} )\end{matrix} ;$$

In the formula, ω* and E* are the control commands for frequency and voltage generated by the droop control link, respectively. P and Q are the output active power and the reactive power detected by the inverter, respectively. P₀ and Q₀ are the active power and the reactive power output by the inverter at the frequency ω₀ and voltage E₀, respectively, and P₀ and Q₀ are determined by the inverter according to the power generation state of the distributed power source. kₚ and k_{q} are defined as positive, which are the slopes of the droop control lines of the frequency and the voltage, respectively.

It should be understood that the above description of the microgrid characteristics is not intended to limit the present disclosure. In addition to droop control, a portion of the generators in the microgrid can also adopt improved droop control strategies, such as droop control with a dead band, and other grid-forming control strategies, such as virtual synchronous generator control, in which the microgrid frequency varies with the output power of the sources within the microgrid.

Referring to FIG. 2, three terminals on one side of the pre-charging switch SW₁ are connected to the three terminals SW₁₋ₐ, SW_{1-b}, and SW_{1-c} on the primary side of the series transformer Ts, and three terminals on the other side of SW₁ are electrically short-circuited together. Therefore, after the pre-charging switch SW₁ is closed, the three terminals SWd₁₋ₐ, SW_{1-b}, and SW_{1-c} are electrically connected together. At this time, the structure of the series transformer Ts is equivalent to that of a conventional transformer. The power electronic converter on the secondary side of the series transformer Ts is connected in parallel with the large power grid through the series transformer Ts.

In the case of a three-phase power grid, the internal structure of the phase selection switch SW₃ can be referred to FIG. 2 and FIG. 3; when SW₃ in FIG. 3 is closed, three phase sequences can be selected: phase sequence 1, phase sequence 2, and phase sequence 3, with a difference of 120 degrees between the three phase sequences; a selection criterion for the closing phase sequence is that after the phase selection switch SW₃ is closed under the selected phase sequence, phase angle difference of the power grid voltage phasor on both sides of the line cut CUT is minimized; and for example, referring to FIG. 3, by selecting a suitable closing phase sequence, after the microgrid bus is connected to the microgrid side of the series transformer Ts through the phase selection switch SW₃, the microgrid bus voltage phasor V_{mg}∠θ₂ and the large power grid connection point voltage phasor V_{g}∠θ1 are located in the same sector I, thereby limiting the voltage stress borne by the primary side of the series transformer Ts within the range of 1 time the rated voltage of the power grid.

Referring to FIG. 2, the circuit topology of the power electronic converter is a two-level three-phase half-bridge circuit, including six power transistors S₁, S₂, S₃, S₄, Ss, and S₆, and each of the power transistors includes an anti-parallel body diode or an additional anti-parallel diode; the power transistor S₁ and the power transistor S₄ are connected end to end in sequence to form a first bridge arm, the power transistor S₃ and the power transistor S₆ are connected end to end in sequence to form a second bridge arm, and the power transistor Ss and the power transistor S₂ are connected end to end in sequence to form a third bridge arm; and a switch transistor connection point is a midpoint of a bridge arm. The midpoints of the first bridge arm, the second bridge arm, and the third bridge arm are connected to the secondary side of the series transformer Ts through a three-phase LC filter circuit. Upper ends of the first bridge arm, the second bridge arm, and the third bridge arm are connected to each other to form a common upper end, and lower ends are connected to each other to form a common lower end.

Referring to FIG. 2, the DC side of the structure shown does not have the energy storage and additional control circuit. The DC side buffer resistor Rdc is connected in parallel with the buffer resistor bypass switch SW₂, and the connection is connected in series with the common upper end and then connected to the positive or negative terminal of the DC-side capacitor C_{dc}. The common lower end is connected to the lower end of the DC-side capacitor C_{dc}.

It should be understood that this structure is not intended to limit the present disclosure. As mentioned above, the specification and structure of the series transformer Ts, the filter circuit structure of the power electronic converter, and the fully controlled power electronic switch device used in the power transistor can adopt different types, and the DC side can also add the energy storage and additional control circuit as needed.

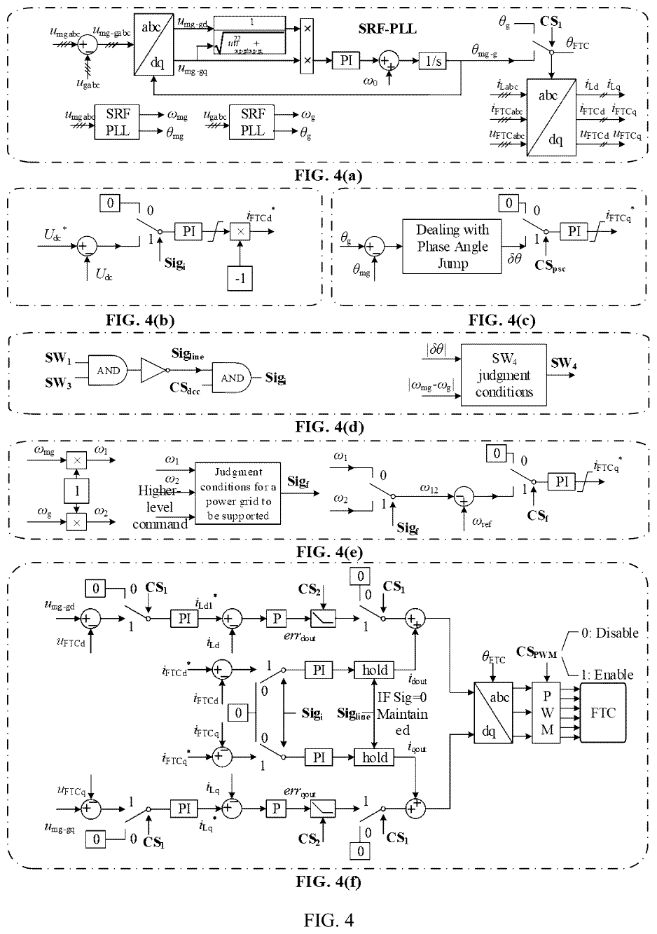

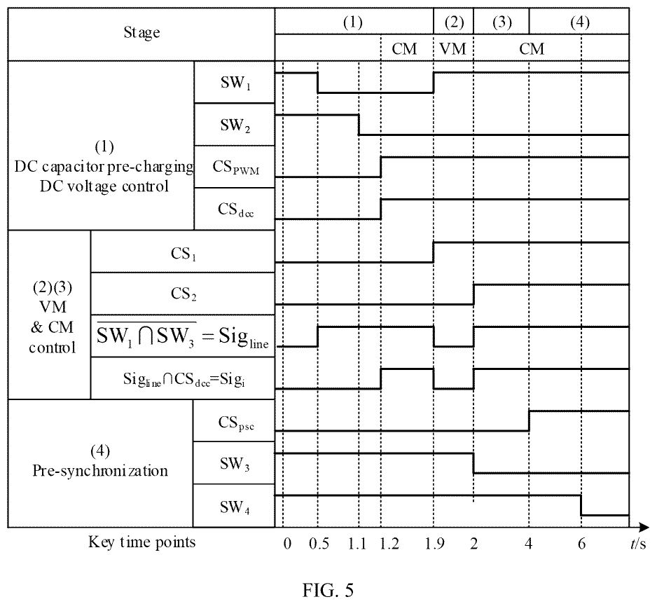

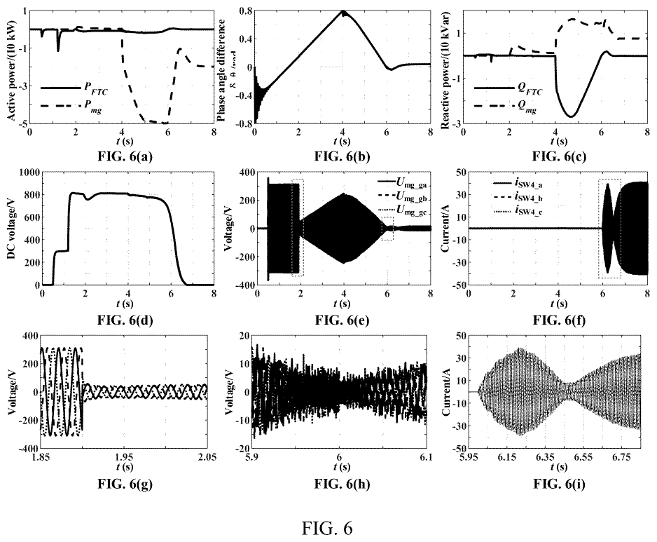

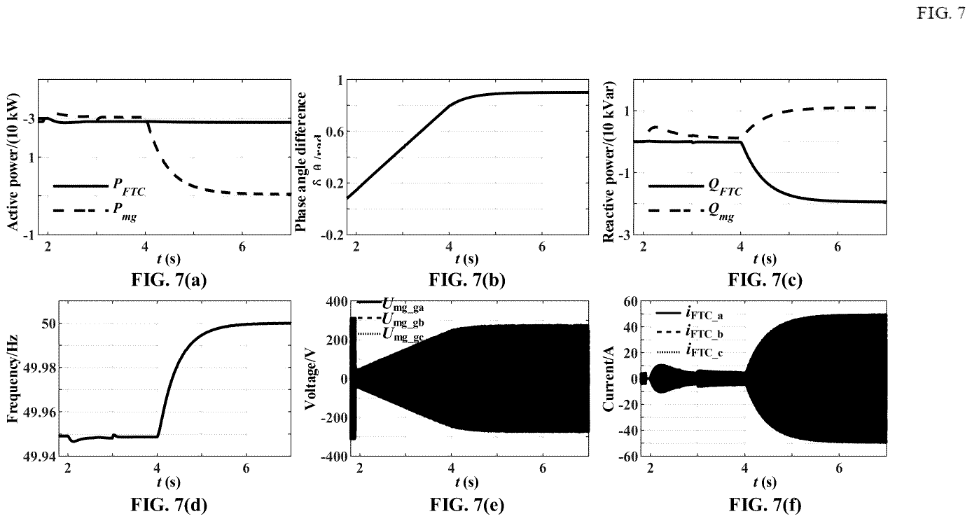

The control method for the series-type flexible transfer converter includes pre-charging self-start control, pre-synchronization and soft-switching control between grids, and emergency power support control. In order to verify the feasibility of the present disclosure, a simulation model is built in simulation software for simulation verification for this specific embodiment; the simulation model includes the entire system of the series-type flexible transfer converter, the three-phase AC microgrid, and the large power grid, as shown in FIG. 2. Three of the inverters, through their respective line impedances, are connected to the microgrid bus as distributed power sources to supply power to active and reactive loads, forming the three-phase AC microgrid. In this embodiment, the relationship between the voltage phasor and the current phasor, and the structure of the phase selection switch SW₃, are shown in FIG. 3. The control system block diagram of the series-type flexible transfer converter is shown in FIG. 4, the timing diagram of the control signal and the switch state is shown in FIG. 5, and the waveform diagrams of relevant electrical quantities in the simulation result are shown in FIG. 6 and FIG. 7.

The following describes a control method for the series-type flexible transfer converter supporting fully autonomous control of a microgrid. The control method is used to control pre-charging self-start of the series-type flexible transfer converter supporting fully autonomous control of a microgrid. A system structure refers to FIG. 2 and FIG. 3, a control system block diagram refers to FIG. 4 (a), FIG. 4 (b), FIG. 4 (d), and FIG. 4 (f), timing of a control signal and a switch state refers to each signal waveform in the time period from 0 s to 1.9 s in FIG. 5, and a waveform diagram of relevant electrical quantities in a simulation result refers to relevant waveform diagrams in the time period from 0 s to 1.9 s in FIG. 6 (a) to FIG. 6 (g).

Before the pre-charging self-start, switches SW₁, SW₂, SW₃, and SW₄ are all in the disconnected state. After the pre-charging self-start is completed, the DC voltage of the power electronic converter is controlled to the DC voltage reference value; it should be noted that for switches SW₁, SW₂, SW₃, and SW₄, the state representation method in FIG. 4 and FIG. 5 is: When the switches are closed, SWᵢ=0 (i=1, 2, 3, 4) and when the switches are open, SWᵢ=1 (i=1, 2, 3, 4); and in FIG. 5, VM represents the voltage mode (VM) and CM represents the current mode (CM).

The specific steps are as follows:
After receiving a start command, the pre-charging switch SW₁ is closed at t=0 s, and the three-phase terminals on the microgrid side of the series transformer Ts are short-circuited. At this time, the actual structure of the series transformer Ts is equivalent to that of a conventional transformer, with the primary side connected to the large power grid and the secondary side connected to the AC port of the power electronic converter. Because all power transistors S₁-S₆ are locked, the large power grid voltage charges the DC-side capacitor C_{dc} through a three-phase diode bridge in an uncontrolled rectification mode. As shown in FIG. 6 (d), after a peak impulse current of charging passes, the voltage value of the DC-side capacitor stabilizes near the magnitude of the AC-side line voltage of the power electronic converter, and the switch SW₂ is closed at t=1.1 s to bypass the buffer resistor R_{dc}.

The control circuit starts working by drawing power autonomously from the DC-side capacitor C_{dc}. As shown in FIG. 5, CS_{PWM}=1 is set at +=1.2 s, and CS_{dec}=1 is set at the same time to start DC voltage control. As shown in FIG. 4 (a), the power electronic converter performs phase-locking of the secondary side voltage of the series transformer Ts to obtain the phase angle θ_{g} of the large power grid voltage, and then the power electronic converter works in a PWM rectifier mode with a unity power factor, and absorbs power from the large power grid. As shown in FIG. 6 (a), the DC voltage is adjusted to the DC voltage reference value of 800 V.

It should be understood that the control method is not intended to limit the present disclosure; if the DC side of the power electronic converter has an energy storage and additional control circuit, the DC voltage control of the series-type flexible transfer converter can also be realized, so that the DC voltage of the power electronic converter follows the DC voltage reference value. At this time, the above-mentioned pre-charging self-start link is not required.

The following describes a control method for the series-type flexible transfer converter supporting fully autonomous control of a microgrid. The control method is used to control pre-synchronization between a microgrid and a large power grid. A system structure refers to FIG. 2 and FIG. 3, a control system block diagram refers to FIG. 4 (a) to FIG. 4 (d) and FIG. 4 (f), timing of a control signal and a switch state refers to each signal waveform in the time period after 1.9 s in FIG. 5, and a waveform diagram of relevant electrical quantities in a simulation result refers to relevant waveform diagrams in the time period after 1.9 s in FIG. 6 (a) to FIG. 6 (i).

According to the above-mentioned pre-charging self-start control method, the DC-side capacitor voltage of the power electronic converter is controlled as a reference value; afterwards, active power transmitted between the microgrid and the large power grid is adjusted by the power electronic converter controlling reactive power that is output by an AC port of the power electronic converter, so that a phase angle of the microgrid voltage and a phase angle of the large power grid voltage are pre-synchronized, and then the bypass switch SW₄ is closed, and the pre-synchronization control between the microgrid and the large power grid is completed.

The specific steps are as follows:
step 1), starting the series-type flexible transfer converter supporting fully autonomous control of a microgrid, and controlling the DC-side capacitor voltage to a reference value, and after receiving a pre-synchronization command, as shown in FIG. 5, disconnecting the pre-charging switch SW₁ at t=1.9s;
step 2), selecting a closing phase sequence of a phase selection switch SW₃, in which the control circuit selects a closing phase sequence of SW₃ according to the relative relationship between a microgrid voltage phasor and a large power grid voltage phasor; a selection criterion for the closing phase sequence is that after the phase selection switch SW₃ is closed under the selected phase sequence, a phase angle difference of power grid voltage phasors on both sides of a line cut CUT is minimized, referring to FIG. 2, that is, a voltage difference between two ends of a primary side of the series transformer Ts is minimized and does not exceed 1 time the rated voltage of the power grid; and in the simulation of the specific embodiment, when the closing phase sequence is phase sequence 1, as shown in FIG. 3, a phase angle difference between the power grid voltage phasor and the microgrid voltage phasor is minimized, both located within sector I;
step 3), according to the phase sequence selected in step 2), as shown in FIG. 5, setting CS₁=1 at t=1.9 s, and switching the phase-locked voltage object of the power electronic converter from the large power grid voltage to the voltage difference between the microgrid and the large grid, in which as shown in FIG. 4 (a), the phase angle θ_{FTC} is switched from θ_{g} to θ_{mg-g}; the power electronic converter works in the voltage mode (VM), and the mode takes an instantaneous value of the voltage difference between the two power grids under the phase sequence selected in step 2) as a voltage command and controls the power electronic converter to make the line cut CUT in FIG. 1, that is, the voltage on the primary side of the series transformer Ts in FIG. 2, follow the voltage command, so that under the selected phase sequence, a voltage amplitude difference between two ends of the phase selection switch SW₃ is zero before the phase selection switch SW₃ is closed; the voltage waveform of the primary side of the series transformer Ts controlled by the power electronic converter is shown in FIG. 6 (e), and the voltage waveform changes with the variation of the voltage difference between the microgrid and the large power grid; it should be noted that in step 3), the power electronic converter works in voltage mode and cannot absorb active power from the AC port thereof to maintain the stability of the DC voltage, and because of losses, as shown in FIG. 6 (d), the DC voltage drops slightly, but the drop is small and does not affect the normal operation of the power electronic converter; and as shown in FIG. 5, phase selection switch SW₃ is closed at t=2 s according to the selected phase sequence to establish electrical connections between the microgrid, the series transformer Ts and a device connected to the series transformer, and the large grid;
step 4), after the phase selection switch SW₃ is closed, setting CS₂=1 at t=2 s as shown in FIG. 5, and transitioning the power electronic converter from the voltage mode (VM) to a current mode (CM), in which as shown in FIG. 4 (d), when Sigₗᵢₙₑ=1, Sigᵢ=1; as shown in FIG. 4 (f), the outputs of the d-axis and the q-axis of the voltage control link gradually decrease from the value at t=2 s to 0 under the control of CS₂; because Sigₗᵢₙₑ=Sigᵢ=1, the current control loop is started, enabling direct control of the current of the dq-axis; and after 1 s, the transition process ends, the voltage control loop in FIG. 4 (f) exits, and the power electronic converter works completely in current mode;
step 5), as shown in FIG. 5, setting CSpsc=1 at t=4 s and starting pre-synchronization control, in which as shown in FIG. 4 (b), a difference between a DC voltage reference value and a DC voltage actual value of the power electronic converter is calculated and sent to a DC voltage controller to obtain an active current command to maintain the stability of the DC voltage; and as shown in FIG. 4 (c), a phase angle difference of the grid voltages at both ends of the primary side of the series transformer Ts is processed by a phase angle jump and sent to a phase angle difference controller to obtain a reactive current command of the power electronic converter;
step 6), according to the voltage command obtained in step 3) or the current command obtained in step 5), after the control circuit combines an actual voltage and current, generating a modulation wave by using voltage closed-loop control in FIG. 4 (f) or current closed-loop control, generating a drive signal through a pulse width modulation process, and controlling turning on or off of each of the power transistors according to the obtained drive signal by a drive circuit of each of the power transistors in the power electronic converter; and
step 7), repeating step 5) and step 6), as shown in FIG. 6 (b), so that frequencies and phase angles of the voltages at both ends gradually tend toward synchronization. When a frequency difference and a phase angle difference of the voltages at both ends are both less than respective thresholds in FIG. 4 (d), the bypass switch SW₄ is closed at t=6 s as shown in FIG. 5, the microgrid is softly switched to being connected to the large power grid through the bypass switch SW₄ and the series reactance Xᵢₙₛ. The grid-connected current flows through the bypass switch SW₄ as shown in FIG. 6 (f) and FIG. 6 (i) and quickly reaches a steady state.

As shown in FIG. 4 (b) and FIG. 4 (c), the active current command and the reactive current command of the power electronic converter are as follows:

$$\{ \begin{matrix}{i}_{FTCd}^{*} = {G}_{p} \cdot ( {u}_{dc \_ ref} - {u}_{dc} ) \\ {i}_{FTCq}^{*} = {G}_{q} \cdot ( {θ}_{mg} - {θ}_{g} )\end{matrix}$$

in which, i*_{FTCd} and i*_{FTCq} are the active current command and reactive current command of the power electronic converter, respectively. Gₚ and G_{q} represent the DC voltage controller and the phase angle difference controller, respectively. In FIG. 4, the DC voltage controller and the phase angle difference controller are both proportional integral (PI) controllers, u_{dc_ref} and u_{dc} are the DC voltage reference value and the DC voltage actual value of the power electronic converter, respectively. θ_{mg} and θ_{g} are the phase angles of the voltage fundamental components on the microgrid side and the large grid side, respectively.

Referring to the sub-figures of FIG. 5 and FIG. 6, the simulation results of the above-mentioned pre-charging self-start and pre-synchronization soft-switching control are systematically described in chronological order.

At t=0.5 s, as shown in FIG. 5, the pre-charging switch SW₁ is closed, and the secondary side voltage of the series transformer Ts charges the DC capacitor Cdc in an uncontrolled rectification mode. As shown in FIG. 6 (a), the DC voltage rises to about 300 V at 0.75 s. As shown in FIG. 5, at 1=1.1 s, after a peak impulse current passes, the buffer resistor bypass switch SW₂ is closed to bypass the buffer resistor R_{dc}; and as shown in FIG. 5, at t=1.2 s, CS_{PWM} and CS_{dcc} are set to 1, the DC voltage control loop of the power electronic converter in FIG. 4 (b) starts, and at 1.4 s the DC voltage is controlled to the DC voltage reference value 800 V, and the pre-charging self-start process is completed.

After receiving a pre-synchronization command, at t=1.9 s, the pre-charging switch SW₁ is disconnected. According to the aforementioned closing phase sequence selection criterion of the phase selection switch SW₃, the closing phase sequence of SW₃ is selected according to the relative relationship between a first power grid voltage phasor and a second power grid voltage phasor; CS₁ is set to 1, and the power electronic converter works in voltage mode. As shown in FIG. 6 (e), the power electronic converter controls the primary side voltage of the series transformer Ts to follow an instantaneous value of the voltage difference between the two power grids under the selected closing phase sequence. During this process, the power electronic converter cannot absorb active power from a line, and the DC voltage in FIG. 6 (a) drops slightly. At 1=2 s, according to the above-mentioned closing phase sequence selection criterion, the phase selection switch SW₃ is closed, the microgrid is connected to a side of the primary side of the series transformer Ts, with CS₂₌₁, and the transition from the voltage mode to the current mode begins. As shown in FIG. 6 (a), the DC voltage quickly recovers to 800 V, and the transition is completed after 1 s. The power electronic converter works in current mode.

As shown in FIG. 5, at +=4 s, CSpcc=1, pre-synchronization control starts. As shown in FIG. 6 (a) and FIG. 6 (c), the series-type flexible transfer converter adjusts the active power transmitted between the microgrid and the large grid by controlling the reactive power output by itself, thereby adjusting the frequency of the microgrid. Correspondingly, as shown in FIG. 6 (b), under the selected closing phase sequence, the phase angle difference of the grid voltages on both sides gradually decreases to zero, and at the same time, the voltage at both ends of the primary side of the series transformer Ts gradually decreases during the pre-synchronization process. Therefore, as shown in FIG. 6 (d), the DC voltage cannot be maintained at the DC voltage reference value of 800 V after t=6 s and drops rapidly. However, the pre-synchronization has been completed at this time, the bypass switch SW₄ is closed, and the microgrid is directly connected to the large power grid through bypass branch SWX. As shown in FIG. 6 (f), the grid-connected current flows through the bypass switch SW₄ and quickly reaches a steady state.

The following introduces another control method for a series-type flexible transfer converter supporting fully autonomous control of a microgrid, which is used to realize emergency power support of the power grid. A system structure refers to FIG. 2 and FIG. 3, a control system block diagram refers to FIG. 4 (a), FIG. 4 (b), FIG. 4 (d), FIG. 4 (e), and FIG. 4 (f), and a waveform diagram of relevant electrical quantities in a simulation result refers to FIG. 7.
in which the another control method includes the following steps:
step 1), starting the series-type flexible transfer converter supporting fully autonomous control of a microgrid, and controlling a DC-side capacitor voltage to a reference value;
step 2), detecting frequencies of a microgrid and a large power grid, determining whether the microgrid or the large power grid needs the emergency power support according to a set power grid frequency threshold, and identifying a power grid to be supported; or identifying the power grid to be supported according to a higher-level command; according to a judgment condition in FIG. 4 (d), after detecting that the microgrid frequency is lower than 49.95 Hz in FIG. 7 (d), identifying that the microgrid is a grid to be supported, and disconnecting a pre-charging switch SW₁;
step 3), selecting a closing phase sequence of a phase selection switch SW₃, in which the control circuit selects a closing phase sequence of SW₃ according to the relative relationship between a microgrid voltage phasor and a large power grid voltage phasor; a selection criterion for the closing phase sequence is that after the phase selection switch SW₃ is closed under the selected phase sequence, a phase angle difference of power grid voltage phasors on both sides of a line cut CUT is minimized, referring to FIG. 2, that is, a voltage difference between two ends of a primary side of the series transformer Ts is minimized and does not exceed 1 time the rated voltage of the power grid; and in the simulation of the specific embodiment, when the closing phase sequence is phase sequence 1, as shown in FIG. 3, a phase angle difference between the power grid voltage phasor and the microgrid voltage phasor is minimized, both located within sector I;

Step 4), according to the phase sequence selected in step 3), setting CS₁=1 at t=1.9 s, and switching the phase-locked voltage object of the power electronic converter from the large power grid voltage to the voltage difference between the microgrid and the large grid, in which as shown in FIG. 4 (a), the phase angle θ_{FTC} is switched from 0 g to θmg-g; the power electronic converter works in the voltage mode (VM), and the mode takes an instantaneous value of the voltage difference between the two power grids under the phase sequence selected in step 3) as a voltage command and controls the power electronic converter to make the voltage on the primary side of the series transformer Ts in FIG. 2 follow the voltage command, so that under the selected phase sequence, a voltage amplitude difference between two ends of the phase selection switch SW₃ is zero before the phase selection switch SW₃ is closed; the voltage waveform of the primary side of the series transformer Ts controlled by the power electronic converter is shown in FIG. 7 (e), and the voltage waveform changes with the variation of the voltage difference between the microgrid and the large power grid; and the phase selection switch SW₃ is closed at 1=2 s according to the selected phase sequence to establish electrical connections between the microgrid, the series transformer Ts and a device connected to the series transformer Ts, and the large grid;
step 5), after the phase selection switch SW₃ is closed, setting CS₂=1 at t=2 s, and transitioning the power electronic converter from the voltage mode (VM) to a current mode (CM), in which as shown in FIG. 4 (d), when Sigₗᵢₙₑ=1, Sigᵢ=1; as shown in FIG. 4 (f), the outputs of the d-axis and the q-axis of the voltage control link gradually decrease from the value at t=2 s to 0 under the control of CS₂; because Sigₗᵢₙₑ=Sigᵢ=1, the current control loop is started, and the current of the d-axis and the q-axis can be directly controlled; and after 1 s, the transition process ends, the voltage control loop in FIG. 4 (f) exits, and the power electronic converter works completely in current mode;
step 6), after the power electronic converter enters the current mode, as shown in FIG. 4 (b), calculating a difference between a DC voltage reference value and a DC voltage actual value of the power electronic converter, and sending the difference to a DC voltage controller of the control circuit to obtain an active current command of the power electronic converter; as shown in FIG. 4 (e), calculating a difference between a frequency reference value and a frequency actual value of the power grid to be supported, and sending the difference to an emergency power support controller of the control circuit to obtain a reactive current command of the power electronic converter; and
the active current command and the reactive current command of the power electronic converter are as follows:

$$\{ \begin{matrix}{i}_{FTCd}^{*} = {G}_{p} \cdot ( {u}_{dc \_ ref} - {u}_{dc} ) \\ {i}_{FTCq}^{*} = {G}_{f} \cdot ( {ω}_{ref} - {ω}_{12} )\end{matrix}$$

in which, i*_{FTCd} and i*_{FTCq} are the active current command and the reactive current command of the power electronic converter, respectively. Gₚ and G_{f} represent the DC voltage controller and the emergency power support controller, respectively. u_{dc_ref} and u_{dc} are the DC voltage reference value and the DC voltage actual value of the power electronic converter, respectively. ω_{ref} and ω₁₂ are the frequency reference value and the frequency actual value of the power grid to be supported, respectively; and
step 7), according to the current command obtained in step 6), as shown in FIG. 4 (f), generating a modulation wave by the control circuit using current closed-loop control, generating a drive signal through a pulse width modulation process, and controlling turning on or off of each of the power transistors according to the obtained drive signal by a drive circuit of each of the power transistors in the power electronic converter. As shown in FIG. 7 (f), a current used for emergency power support flows through the primary side of the series transformer Ts. As shown in FIG. 7 (a), the large grid transmits active power to the grid to be supported, that is, the microgrid, thereby realizing the emergency power support for the microgrid; and as shown in FIG. 7 (d), after obtaining the emergency power support, the microgrid frequency returns to the frequency reference value ω_{ref} of the grid to be supported.

The above are merely preferred embodiments of the present disclosure and are not intended to limit the present disclosure in any form. Any simple modifications, changes, and equivalent structural variations made to the above embodiments based on the technical essence of the present disclosure still fall within the protection scope of the technical solution of the present disclosure.

Finally, it should be noted that the above embodiments are only used to illustrate the technical solutions of the present disclosure and not to limit them. Although the present disclosure is described in detail with reference to the above embodiments, ordinary technicians in the field can still make modifications or equivalent substitutions to the specific embodiments of the present disclosure, and any such modification or equivalent substitution that does not deviate from the spirit and scope of the present disclosure should be covered within the scope of protection of the claims of the present disclosure.

What is claimed is:

1. A series-type flexible transfer converter supporting fully autonomous control of a microgrid, comprising a main circuit and a control circuit for controlling operation of the main circuit, wherein the main circuit comprises a pre-charging switch SW₁, a phase selection switch SW₃, a bypass switch SW₄, a line cut CUT, and a power electronic converter for converting DC into AC, wherein the line cut CUT is connected in parallel with the bypass switch SW₄; and an AC side of the power electronic converter is connected to the line cut CUT, and an end of a parallel structure of the line cut CUT and the bypass switch SW₄ is connected in parallel with the pre-charging switch SW₁ and then connected in series with the phase selection switch SW₃; and
a buffer resistor R_{dc} is connected in series with a positive or negative end of a DC-side capacitor C_{dc} of the power electronic converter, and a buffer resistor bypass switch SW₂ is connected in parallel with both ends of the buffer resistor R_{dc} at the positive or negative end of the DC-side capacitor C_{dc}; and the number of phases of the pre-charging switch SW₁, the number of phases of the phase selection switch SW₃, the number of phases of the bypass switch SW₄, and the number of phases of the power electronic converter are the same as the number of phases of a power grid.

2. The series-type flexible transfer converter supporting fully autonomous control of a microgrid according to claim 1, wherein a series transformer Tₛ is provided between the power electronic converter and the line cut CUT, and both ends of a primary side of the series transformer Tₛ are connected to the line cut CUT, and a secondary side of the series transformer Tₛ is connected to the AC side of the power electronic converter.

3. The series-type flexible transfer converter supporting fully autonomous control of a microgrid according to claim 1, wherein the bypass switch SW₄ is connected in series with a series reactance Xᵢₙₛ.

4. The series-type flexible transfer converter supporting fully autonomous control of a microgrid according to claim 1, wherein a DC side of the power electronic converter has an energy storage and an additional control circuit.

5. A control method for the series-type flexible transfer converter supporting fully autonomous control of a microgrid according to claim 1, wherein the control method is used to control pre-charging self-start of the series-type flexible transfer converter supporting fully autonomous control of a microgrid and is implemented by a control circuit controlling a main circuit, wherein the control method comprises the following process:
before a pre-charging self-start process starts, a pre-charging switch SW₁, a buffer resistor bypass switch SW₂, a phase selection switch SW₃, and a bypass switch SW₄ are all in the disconnected state;
when the power grid is a single-phase power grid, one end of the pre-charging switch SW₁ is connected to a phase line of a power grid and the other end is connected to a neutral line of the power grid; after a pre-charging command is received, the pre-charging switch SW₁ is closed, power transistors in a power electronic converter are all locked at this time, and a power grid voltage charges the DC-side capacitor through an uncontrolled rectifier; and after a peak impulse current of charging disappears, the buffer resistor bypass switch SW₂ is closed to bypass a buffer resistor R_{dc};
when the power grid is a three-phase power grid, three terminals at one end of the pre-charging switch SW₁ connected to the power grid are connected to three phases of the power grid, and three terminals at the other end are electrically connected together; after the pre-charging command is received, the pre-charging switch SW₁ is closed, the three-phase terminals of SW₁ connected to the one end of the power grid are short-circuited, the power transistors in the power electronic converter are all locked at this time, and the power grid voltage charges the DC-side capacitor through the uncontrolled rectifier; and after the peak impulse current of charging disappears, the buffer resistor bypass switch SW₂ is closed to bypass the buffer resistor R_{dc}; and
the control circuit starts working by drawing power autonomously from the DC-side capacitor, and then controls the power electronic converter to perform phase-locking of an AC port voltage of the power electronic converter, to work in a PWM rectifier mode with a unity power factor, and to absorb active power from the power grid so that a DC-side capacitor voltage is adjusted to a reference value.

6. A control method for the series-type flexible transfer converter supporting fully autonomous control of a microgrid according to claim 1, wherein the control method is used to control a pre-synchronization between a first power grid and a second power grid, and a phase selection switch SW₃ is connected to the first power grid, and the other end of a parallel structure of a line cut CUT and a bypass switch SW₄ is connected to the second power grid, and the control method is implemented by a control circuit controlling a main circuit, wherein the control method comprises the following process:
when a DC side of a power electronic converter has an energy storage and additional control circuit, active power transmitted between the first power grid and the second power grid is adjusted directly by the power electronic converter controlling reactive power that is output by an AC port of the power electronic converter, so that a phase angle of the first power grid voltage and a phase angle of the second power grid voltage are pre-synchronized, and then the bypass switch SW₄ is closed, and the pre-synchronization control between the first power grid and the second power grid is completed; and
when the DC side of the power electronic converter lacks the energy storage and additional control circuit, the pre-charging self-start of the series-type flexible transfer converter supporting fully autonomous control of a microgrid is performed according to the method comprises the following process:
before a pre-charging self-start process starts, a pre-charging switch SW₁, a buffer resistor bypass switch SW₂, a phase selection switch SW₃, and a bypass switch SW₄ are all in the disconnected state;
when the power grid is a single-phase power grid, one end of the pre-charging switch SW₁ is connected to a phase line of a power grid and the other end is connected to a neutral line of the power grid; after a pre-charging command is received, the pre-charging switch SW₁ is closed, power transistors in a power electronic converter are all locked at this time, and a power grid voltage charges the DC-side capacitor through an uncontrolled rectifier; and after a peak impulse current of charging disappears, the buffer resistor bypass switch SW₂ is closed to bypass a buffer resistor R_{dc};
when the power grid is a three-phase power grid, three terminals at one end of the pre-charging switch SW₁ connected to the power grid are connected to three phases of the power grid, and three terminals at the other end are electrically connected together; after the pre-charging command is received, the pre-charging switch SW₁ is closed, the three-phase terminals of SW₁ connected to the one end of the power grid are short-circuited, the power transistors in the power electronic converter are all locked at this time, and the power grid voltage charges the DC-side capacitor through the uncontrolled rectifier; and after the peak impulse current of charging disappears, the buffer resistor bypass switch SW₂ is closed to bypass the buffer resistor R_{dc}; and
the control circuit starts working by drawing power autonomously from the DC-side capacitor, and then controls the power electronic converter to perform phase-locking of an AC port voltage of the power electronic converter, to work in a PWM rectifier mode with a unity power factor, and to absorb active power from the power grid so that a DC-side capacitor voltage is adjusted to a reference value;
subsequently, the active power transmitted between the first power grid and the second power grid is adjusted by the power electronic converter controlling the reactive power that is output by the AC port of the power electronic converter, so that the phase angle of the first power grid voltage and the phase angle of the second power grid voltage are pre-synchronized, and then the bypass switch SW₄ is closed, and the pre-synchronization control between the first power grid and the second power grid is completed.

7. The control method for the series-type flexible transfer converter supporting fully autonomous control of a microgrid according to claim 6, wherein the control method specifically comprises the following steps:
step 1), starting the series-type flexible transfer converter supporting fully autonomous control of a microgrid, controlling the DC-side capacitor voltage to a reference value, and disconnecting the pre-charging switch SW₁ after receiving a pre-synchronization command;
step 2), selecting a closing phase sequence of the phase selection switch SW₃, wherein the phase selection switch SW₃ only needs to select the closing phase sequence when the first power grid and the second power grid are three-phase power grids; the control circuit selects the closing phase sequence of SW₃ according to the relative relationship between a first power grid voltage phasor and a second power grid voltage phasor; and a selection criterion for the closing phase sequence is that after the phase selection switch SW₃ is closed under the selected phase sequence, phase angle difference of the power grid voltage phasor on both sides of the line cut CUT is minimized;
step 3), making the power electronic converter work in a voltage mode through the control circuit, wherein in the case of a single-phase power grid, an instantaneous value of a voltage difference between the first power grid and the second power grid is sampled and calculated as a voltage command, and then the power electronic converter is controlled to make voltages at both ends of the line cut CUT follow the voltage command, so that a voltage amplitude difference between two ends of the phase selection switch SW₃ is zero before the closing thereof; and subsequently, the phase selection switch SW₃ is closed to establish an electrical connection between the first power grid, the line cut CUT and a device connected to the line cut CUT and the second power grid; and
in the case of a three-phase power grid, in the voltage mode, according to the phase sequence selected in step 2), an instantaneous value of the voltage difference between the first power grid and the second power grid is sampled and calculated as a voltage command, and then the power electronic converter is controlled to make voltages at both ends of the line cut CUT follow the voltage command, so that under the selected phase sequence, a voltage amplitude difference between two ends of the phase selection switch SW₃ is zero before the phase selection switch SW₃ is closed; and subsequently, closing the phase selection switch SW₃ according to the selected phase sequence to establish an electrical connection between the first power grid, the line cut CUT and the device connected to the line cut CUT and the second power grid;
step 4), after the phase selection switch SW₃ is closed, transitioning the power electronic converter from the voltage mode to a current mode, and completing the transition to lead the power electronic converter to work in the current mode;
step 5), after the power electronic converter enters the current mode, calculating a difference between a DC voltage reference value and a DC voltage actual value of the power electronic converter, and sending the difference to a DC voltage controller of the control circuit to obtain an active current command; and processing a phase angle difference of voltages at both ends of the parallel structure of the line cut CUT and the bypass switch SW₄ through a phase jump, and sending the phase angle difference to a phase angle difference controller of the control circuit to obtain a reactive current command of the power electronic converter;
step 6), according to the voltage command obtained in step 3) or the current command obtained in step 5), after the control circuit combines an actual voltage and current, generating a modulation wave by using voltage closed-loop control or current closed-loop control, generating a drive signal through a pulse width modulation process, and controlling turning on or off of each of the power transistors according to the obtained drive signal by a drive circuit of each of the power transistors in the power electronic converter; and
step 7), repeating step 5) to step 6), so that frequencies and phase angles of the voltages at both ends of the parallel structure of the line cut CUT and the bypass switch SW₄ tend toward synchronization, and when a frequency difference and a phase angle difference of the voltages at both ends of the parallel structure of the line cut CUT and the bypass switch SW₄ are both less than respective thresholds, switching to connect the first power grid to the second power grid through the bypass switch SW₄.

8. The control method for the series-type flexible transfer converter supporting fully autonomous control of a microgrid according to claim 7, wherein the active current command and the reactive current command of the power electronic converter are as follows:
$$\{ \begin{matrix}{i}_{FTCd}^{*} = {G}_{p} \cdot ( {u}_{dc \_ ref} - {u}_{dc} ) \\ {i}_{FTCq}^{*} = {G}_{q} \cdot ( {θ}_{1} - {θ}_{2} )\end{matrix}$$
wherein, i*_{FTCd} and i*_{FTCq} are the active current command and the reactive current command of the power electronic converter, respectively, Gₚ and G_{q} represent the DC voltage controller and the phase angle difference controller, respectively, u_{dc_ref} and u_{dc} are the DC voltage reference value and the DC voltage actual value of the power electronic converter, respectively, and θ₁ and θ₂ are the phase angles of voltage fundamental components of the first power grid and the second power grid, respectively.

9. The control method for the series-type flexible transfer converter supporting fully autonomous control of a microgrid according to claim 6, wherein voltage levels of the first power grid and the second power grid are the same, or the voltage levels are different but become the same voltage level after an additional step-up or step-down transformer;
the first power grid is a three-phase or single-phase AC microgrid, and the second power grid is a three-phase or single-phase large power grid;
or the first power grid is a three-phase or single-phase large power grid, and the second power grid is a three-phase or single-phase AC microgrid;
or the first power grid and the second power grid are two three-phase or single-phase AC microgrids; and
at least a portion of distributed power sources in the microgrid adopt grid-forming control with active power-frequency droop.

10. A control method for the series-type flexible transfer converter supporting fully autonomous control of a microgrid according to claim 1, wherein the control method is used to realize emergency power support of a power grid, and a phase selection switch SW₃ is connected to a first power grid, and another end of a parallel structure of a line cut CUT and a bypass switch SW₄ is connected to a second power grid, and the control method is implemented by a control circuit controlling a main circuit, wherein the control method comprises the following process:
when a DC side of a power electronic converter has an energy storage and additional control circuit, active power transmitted between the first power grid and the second power grid is adjusted by a power electronic converter controlling reactive power that is output by an AC port of the power electronic converter, so as to complete emergency power support for a certain power grid; when the DC side of the power electronic converter lacks the energy storage and additional control circuit, the pre-charging self-start of the series-type flexible transfer converter supporting fully autonomous control of a microgrid is performed according to the method comprises the following process:
before a pre-charging self-start process starts, a pre-charging switch SW₁, a buffer resistor bypass switch SW₂, a phase selection switch SW₃, and a bypass switch SW₄ are all in the disconnected state;
when the power grid is a single-phase power grid, one end of the pre-charging switch SW₁ is connected to a phase line of a power grid and the other end is connected to a neutral line of the power grid; after a pre-charging command is received, the pre-charging switch SW₁ is closed, power transistors in a power electronic converter are all locked at this time, and a power grid voltage charges the DC-side capacitor through an uncontrolled rectifier; and after a peak impulse current of charging disappears, the buffer resistor bypass switch SW₂ is closed to bypass a buffer resistor R_{dc};
when the power grid is a three-phase power grid, three terminals at one end of the pre-charging switch SW₁ connected to the power grid are connected to three phases of the power grid, and three terminals at the other end are electrically connected together; after the pre-charging command is received, the pre-charging switch SW₁ is closed, the three-phase terminals of SW₁ connected to the one end of the power grid are short-circuited, the power transistors in the power electronic converter are all locked at this time, and the power grid voltage charges the DC-side capacitor through the uncontrolled rectifier; and after the peak impulse current of charging disappears, the buffer resistor bypass switch SW₂ is closed to bypass the buffer resistor R_{dc}; and
the control circuit starts working by drawing power autonomously from the DC-side capacitor, and then controls the power electronic converter to perform phase-locking of an AC port voltage of the power electronic converter, to work in a PWM rectifier mode with a unity power factor, and to absorb active power from the power grid so that a DC-side capacitor voltage is adjusted to a reference value;
the active power transmitted between the first power grid and the second power grid is adjusted by the power electronic converter controlling the reactive power that is output by the AC port of the power electronic converter, so as to complete the emergency power support for a certain power grid;
wherein the control method comprises the following steps:
step 1), starting the series-type flexible transfer converter supporting fully autonomous control of a microgrid, and controlling a DC-side capacitor voltage to a reference value;
step 2), detecting frequencies of the first power grid and the second power grid, determining whether the first or the second power grid needs the emergency power support according to a set power grid frequency threshold, and identifying a power grid to be supported; or identifying the power grid to be supported according to a higher-level command; and after identifying the power grid to be supported, disconnecting a pre-charging switch SW₁;
step 3), selecting a closing phase sequence of the phase selection switch SW₃, wherein the phase selection switch SW₃ only needs to select the closing phase sequence when the first power grid and the second power grid are three-phase power grids; the control circuit selects the closing phase sequence of SW₃ according to the relative relationship between a first power grid voltage phasor and a second power grid voltage phasor; and a selection criterion for the closing phase sequence is that after the phase selection switch SW₃ is closed under the selected phase sequence, phase angle difference of the power grid voltage phasor on both sides of the line cut CUT is minimized;
step 4), making the power electronic converter work in a voltage mode through the control circuit, wherein in the case of a single-phase power grid, an instantaneous value of a voltage difference between the first power grid and the second power grid is sampled and calculated as a voltage command, and then the power electronic converter is controlled to make voltages at both ends of the line cut CUT follow the voltage command, so that a voltage amplitude difference between two ends of the phase selection switch SW₃ is zero before the closing thereof, and subsequently, the phase selection switch SW₃ is closed to establish an electrical connection between the first power grid, the line cut CUT and a device connected to the line cut CUT and the second power grid; and
in the case of a three-phase power grid, in the voltage mode, according to the phase sequence selected in step 3), an instantaneous value of the voltage difference between the first power grid and the second power grid is sampled and calculated as a voltage command, and then the power electronic converter is controlled to make voltages at both ends of the line cut CUT follow the voltage command, so that under the selected phase sequence, a voltage amplitude difference between two ends of the phase selection switch SW₃ is zero before the phase selection switch SW₃ is closed; and subsequently, the phase selection switch SW₃ is closed according to the selected phase sequence to establish an electrical connection between the first power grid, the line cut CUT and the device connected to the line cut CUT and the second power grid;
step 5), after the phase selection switch SW₃ is closed, transitioning the power electronic converter from the voltage mode to a current mode, and completing the transition to lead the power electronic converter to work in the current mode;
step 6), after the power electronic converter enters the current mode, calculating a difference between a DC voltage reference value and a DC voltage actual value of the power electronic converter, and sending the difference to a DC voltage controller of the control circuit to obtain an active current command of the power electronic converter; and calculating a difference between a frequency reference value and a frequency actual value of the power grid to be supported, and sending the difference to an emergency power support controller of the control circuit to obtain a reactive current command of the power electronic converter; wherein
the active current command and the reactive current command of the power electronic converter are as follows:
$$\{ \begin{matrix}{i}_{FTCd}^{*} = {G}_{p} \cdot ( {u}_{dc \_ ref} - {u}_{dc} ) \\ {i}_{FTCq}^{*} = {G}_{f} \cdot ( {ω}_{ref} - {ω}_{12} )\end{matrix}$$
wherein, i*_{FTCd} and i*_{FTCq} are the active current command and the reactive current command of the power electronic converter, respectively, Gₚ and G_{f} represent the DC voltage controller and the emergency power support controller, respectively, u_{dc_ref} and u_{dc} are the DC voltage reference value and the DC voltage actual value of the power electronic converter, respectively, and ω_{ref} and ω₁₂ are the frequency reference value and the frequency actual value of the power grid to be supported, respectively; and
step 7), according to the current command obtained in step 6), generating a modulation wave by the control circuit using current closed-loop control, generating a drive signal through a pulse width modulation process, and controlling turning on or off of each of the power transistors according to the obtained drive signal by a drive circuit of each of the power transistors in the power electronic converter, so as to realize transmission of the active power to the power grid to be supported and the emergency power support for the power grid.
